(19) United States
(12) Patent Application Publication
(10) Pub. No.: US 2014/0193704 A1
(43) Pub. Date: Jul. 10, 2014

(54) RECHARGEABLE BATTERY

(71) Applicants: Robert Bosch GmbH, Stuttgart (DE); Samsung SDI Co., Ltd., Yongin-si (KR)

(72) Inventor: Duk-Jung KIM, Yongin-si (KR)

(21) Appl. No.: 13/917,778

(22) Filed: Jun. 14, 2013

(30) Foreign Application Priority Data
Jan. 9, 2013 (KR) 10-2013-0002543

(51) Int. Cl. H01M 2/30; H01M 2/06

(52) U.S. Cl. CPC H01M 2/30; H01M 2/06
USPC 429/179

(57) ABSTRACT

A rechargeable battery may include a case that receives an electrode assembly, a cap plate that closes and seals an opening of the case, an electrode terminal that passes through the cap plate and is electrically connected to the electrode assembly, an insulator between the electrode terminal and the cap plate, the insulator electrically insulating the electrode terminal and the cap plate, and an electrification switch in the insulator. The electrification switch may electrically connect the electrode terminal to the cap plate according to manipulation of the electrification switch.

### CROSS-REFERENCE TO RELATED APPLICATION

This application claims priority to and the benefit of Korean Patent Application No. 10-2013-0002543 filed in the Korean Intellectual Property Office on Jan. 9, 2013, and entitled: “RECHARGEABLE BATTERY,” the entire contents of which are incorporated herein by reference.

### BACKGROUND

1. Field

Embodiments relate to a rechargeable battery.

2. Description of the Related Art

A rechargeable battery may be repeatedly charged and discharged, unlike a primary battery that cannot be recharged. A low-capacity rechargeable battery may be used for small portable electronic devices, such as mobile phones, laptop computers, and camcorders. A large-capacity battery may be used as a power source for driving motors, such as for hybrid vehicles.

### SUMMARY

Embodiments are directed to a rechargeable battery. The rechargeable battery may include a case that receives an electrode assembly, a cap plate that closes and seals an opening of the case, an electrode terminal that passes through the cap plate and is electrically connected to the electrode assembly, an insulator between the electrode terminal and the cap plate, the insulator electrically insulating the electrode terminal and the cap plate, and an electrification switch in the insulator, the electrification switch electrically connecting the electrode terminal to the cap plate according to manipulation of the electrification switch.

The electrode terminal may include a negative terminal connected to a negative electrode of the electrode assembly, and a positive terminal connected to a positive electrode of the electrode assembly. The insulator may include a positive insulator that insulates the positive terminal, and the electrification switch may be in the positive insulator.

The positive insulator may include a terminal receiver that receives and supports the positive terminal, and a switch receiver that is on one side of the terminal receiver and receives the electrification switch.

The electrification switch may include a button in the switch receiver, and an access member having a first end connected to a portion of the cap plate in the switch receiver, and a second end that electrically accesses the positive terminal according to manipulation of the button.

The button may have a first manipulation state and a second manipulation state. When the button is in the first manipulation state, a top surface of the button may be a first distance from the cap plate and the second end of the access member may be spaced from the positive terminal. When the button is in the second manipulation state, the top surface of the button may be a second distance from the cap plate, and the second end of the access member may contact the positive terminal. The first distance may be greater than the second distance.

The button may include a hook that hooks onto a protrusion protruding from an internal wall of the switch receiver according to manipulation of the button.

The access member may include a vertical unit that extends in a vertical direction in the switch receiver, and a horizontal unit bent in a horizontal direction from the vertical unit, and the horizontal unit may be pushed in the horizontal direction and may access the positive terminal by pushing the button down.

The button may include a groove that corresponds to the vertical unit and the horizontal unit.

The positive insulator may include a cell barrier that partitions the terminal receiver and the switch receiver, and the cell barrier may define a through hole for the horizontal unit to progress to the positive terminal.

The rechargeable battery may further include an external short-circuit unit between the negative terminal and the cap plate, the short-circuit unit may short-circuit the negative terminal to the cap plate when an internal pressure is increased.

The case and the cap plate may be made of aluminum.

The electrode terminal may include a negative terminal connected to a negative electrode of the electrode assembly, and a positive terminal connected to a positive electrode of the electrode assembly. The insulator may include a negative insulator that insulates the negative terminal, and the electrification switch may be in the negative insulator.

The negative insulator may include a terminal receiver that receives and supports the negative terminal, and a switch receiver that is on one side of the terminal receiver and receives the electrification switch.

The electrification switch may include a button in the switch receiver, and an access member having a first end connected to a portion of the cap plate in the switch receiver, and a second end that electrically accesses the negative terminal according to manipulation of the button.

The button may have a first manipulation state and a second manipulation state. When the button is in the first manipulation state, a top surface of the button may be a first distance from the cap plate and the second end of the access member may be spaced from the negative terminal. When the button is in the second manipulation state, the top surface of the button may be a second distance from the cap plate, and the second end of the access member may contact the negative terminal. The first distance may be greater than the second distance.

The button may include a hook that hooks onto a protrusion protruding from an internal wall of the switch receiver according to manipulation of the button.

The access member may include a vertical unit that extends in a vertical direction in the switch receiver, and a horizontal unit bent in a horizontal direction from the vertical unit, and the horizontal unit may be pushed in the horizontal direction and may access the negative terminal by pushing the button down.

The button may include a groove that corresponds to the vertical unit and the horizontal unit.

The negative insulator may include a cell barrier that partitions the terminal receiver and the switch receiver, the cell barrier may define a through hole for the horizontal unit to progress to the negative terminal.

The case and the cap plate may be made of stainless steel.

### BRIEF DESCRIPTION OF THE DRAWINGS

Features will become apparent to those of skill in the art by describing in detail exemplary embodiments with reference to the attached drawings in which:

FIG. 1 illustrates a rechargeable battery according to a first exemplary embodiment.

FIG. 2 illustrates a cross-sectional view with respect to line II-II of FIG. 1.

FIG. 3 illustrates a cross-sectional view before an electrification switch provided to a positive terminal of FIG. 2 is manipulated.

FIG. 4 illustrates a cross-sectional view when an electrification switch is manipulated in FIG. 3.

FIG. 5 illustrates a perspective view of a rechargeable battery according to a second exemplary embodiment.

FIG. 6 illustrates a cross-sectional view with respect to line VI-VI of FIG. 5.

FIG. 7 illustrates a cross-sectional view before an electrification switch provided to a negative terminal of FIG. 6 is manipulated.

FIG. 8 illustrates a cross-sectional view when an electrification switch is manipulated in FIG. 7.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when an element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

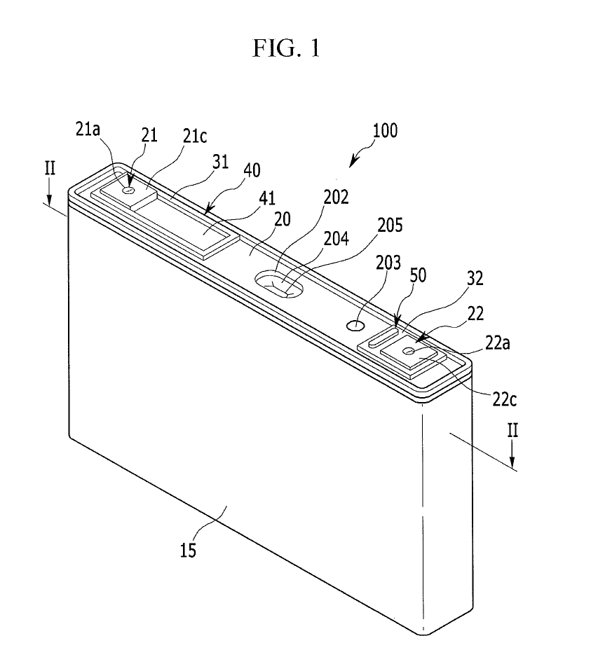

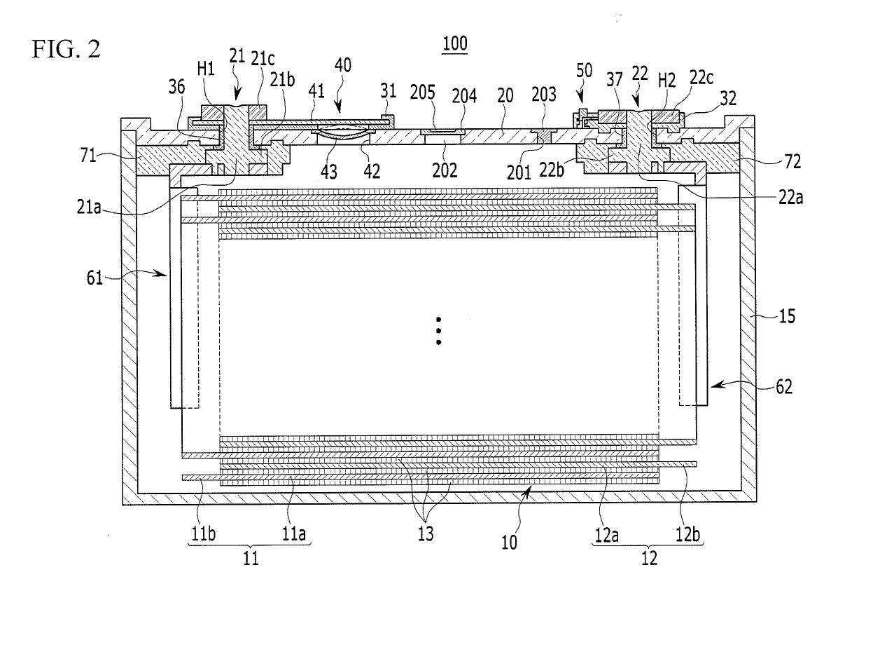

FIG. 1 illustrates a rechargeable battery 100 according to a first exemplary embodiment, and FIG. 2 illustrates a cross-sectional view with respect to line II-II of FIG. 1. Referring to FIG. 1 and FIG. 2, the rechargeable battery 100 may include an electrode assembly 10 for charging and discharging current, a case 15 receiving the electrode assembly 10, and a cap plate 20 combined with an opening of the case 15 and closing and sealing the opening.

The rechargeable battery 100 may further include a pair of electrode terminals (for example, a negative terminal 21 and a positive terminal 22) installed through the cap plate 20, a pair of insulators (for example, a negative insulator 31 and a positive insulator 32) for insulating the electrode terminals 21 and 22, an external short-circuit unit 40 provided to the negative terminal 21, and an electrification switch 50 provided to the positive insulator 32 on the side of the positive terminal 22.

The electrode assembly 10 may be formed by disposing electrodes (for example, a negative electrode 11 and a positive electrode 12) on either side of a separator 13 which is an insulator, and winding the negative electrode 11, the separator 13, and the positive electrode 12 in a jellyroll shape.

The electrode assembly may be assembled by stacking the negative electrode and the positive electrode formed to be a single plate with the separator therebetween or by alternately folding the negative electrode, the separator, and the positive electrode and stacking them (not shown).

The negative electrode 11 and the positive electrode 12 respectively may include coated regions 11a and 12a generated by coating an active material on a current collector of a metal plate, and uncoated regions 11b and 12b on which the active material is not coated and that are formed as an exposed current collector.

The uncoated region 11b of the negative electrode 11 may be formed at an end of one side of the negative electrode 11 along the spirally wound negative electrode 11. The uncoated region 12b of the positive electrode 12 may be formed at an end of one side of the positive electrode 12 along the spirally wound positive electrode 12. That is, the uncoated regions 11b and 12b may be disposed at both ends of the electrode assembly 10.

For example, the case 15 may be formed to be substantially cuboidal and may set a space for receiving the electrode assembly 10 and an electrolyte solution, and an opening for connecting the inner space to an outside may be formed on one side of the cuboid. The opening may allow the electrode assembly 10 to be inserted inside the case 15.

The cap plate 20 may be made of a thin steel plate and may be installed in the opening of the case 15 to close and seal the case 15. The cap plate 20 may further include an electrolyte injection opening 201 and a vent hole 202.

The electrolyte injection opening 201 may close and seal the cap plate 20 combined with the case 15, and may allow injection of the electrolyte solution into the case 15. After the electrolyte solution is injected, the electrolyte injection opening 201 may be sealed by a sealing cap 203.

The vent hole 202 may be closed and sealed with a vent plate 204 and may discharge an internal pressure of the rechargeable battery 100. When the internal pressure of the rechargeable battery 100 reaches a predetermined pressure, the vent plate 204 may be incised to open the vent hole 202. The vent plate 204 may include a notch 205 for guiding the incision.

The negative terminal 21 and the positive terminal 22 may be installed to penetrate through the cap plate 20 and may be electrically connected to the electrode assembly 10. That is, the negative terminal 21 may be electrically connected to the negative electrode 11 of the electrode assembly 10, and the positive terminal 22 may be electrically connected to the positive electrode 12 of the electrode assembly 10. Therefore, the electrode assembly 10 may be drawn to (i.e., electrically connected to) the outside of the case 15 through the negative terminal 21 and the positive terminal 22.

The negative terminal 21 and the positive terminal 22 may have the same configuration inside the cap plate 20 and they may have different configurations outside the cap plate 20, which will now be described.

The negative and positive terminals 21 and 22 may include rivet terminals 21a and 22a installed in terminal holes H1 and H2 of the cap plate 20, flanges 21b and 22b integrally formed on the rivet terminals 21a and 22a from the inside of the cap plate 20, and plate terminals 21c and 22c disposed on an external side of the cap plate 20 and connected to the rivet terminals 21a and 22a through riveting or welding.

Negative and positive gaskets 36 and 37 may be respectively installed between the rivet terminals 21a and 22a of the negative and positive terminals 21 and 22 and the terminal holes H1 and H2 of the cap plate 20, and may seal a portion between the rivet terminals 21a and 22a of the negative and positive terminals 21 and 22 and the cap plate 20. The negative and positive gaskets 36 and 37 may extend between the flanges 21b and 22b and the inside of the cap plate 20 to further seal a portion between the flanges 21b and 22b and the cap plate 20.

Negative and positive lead tabs 61 and 62 may electrically connect the negative and positive terminals 21 and 22 to the negative and positive electrodes 11 and 12 of the electrode assembly 10. That is, the negative and positive lead tabs 61 and 62 may be respectively combined to bottoms of the rivet terminals 21a and 22a to caulk the bottoms so the negative and positive lead tabs 61 and 62 are supported at the flanges 21b and 22b, and are connected to the bottoms of the rivet terminals 21a and 22a with a conductive configuration.

Internal insulators 71 and 72 may be installed between the negative and positive lead tabs 61 and 62 and the cap plate 20 to electrically insulate the negative and positive lead tabs 61 and 62 and the cap plate 20. The internal insulators 71 and 72 may be combined to the cap plate 20 on one side and may wrap around the negative and positive lead tabs 61 and 62, the rivet terminals 21a and 22a, and the flanges 21b and 22b on another side to stabilize their connection structure.

Different configurations of the negative terminal 21 and the positive terminal 22 at the outside of the cap plate 20 will now be described. The external short-circuit unit 40 may be provided to the negative terminal 21, and the electrification switch 50 may be provided to the positive terminal 22. The external short-circuit unit 40 may be separate (separately installed) relative to the electrification switch 50.

The negative terminal 21 and the external short-circuit unit 40 will now be described. The external short-circuit unit 40 may include a short-circuit tab 41 and a short-circuit member 43 that are separated or short-circuited according to an internal pressure of the rechargeable battery 100.

The short-circuit tab 41 may be electrically connected to the rivet terminal 21a of the negative terminal 21, may be provided with the negative insulator 31, and may be disposed outside the cap plate 20. The negative insulator 31 may be provided between the short-circuit tab 41 and the cap plate 20 to electrically insulate the short-circuit tab 41 and the cap plate 20. That is, the cap plate 20 may be electrically insulated from the negative terminal 21.

The short-circuit tab 41 and the plate terminal 21c may be combined with a top of the rivet terminal 21a to caulk the top so the short-circuit tab 41 and the plate terminal 21c are combined with the top of the rivet terminal 21a with a conductive structure (i.e., to be electrically connected to each other). Therefore, the short-circuit tab 41 and the plate terminal 21c may be supported at the portion of the cap plate 20 provided with the negative insulator 31.

The short-circuit member 43 may be installed in a short-circuit hole 42 of the cap plate 20. The short-circuit tab 41 may be connected with the negative terminal 21 and may extend toward the short-circuit member 43. Accordingly, the short-circuit tab 41 may face the short-circuit member 43, which may maintain a separated state (illustrated as the solid line) in the short-circuit hole 42, and (when the internal pressure is increased) the short-circuit member 43 may be reversed to form a short-circuit state (illustrated as the phantom line) so that the short-circuit member 43 contacts the short-circuit tab 41.

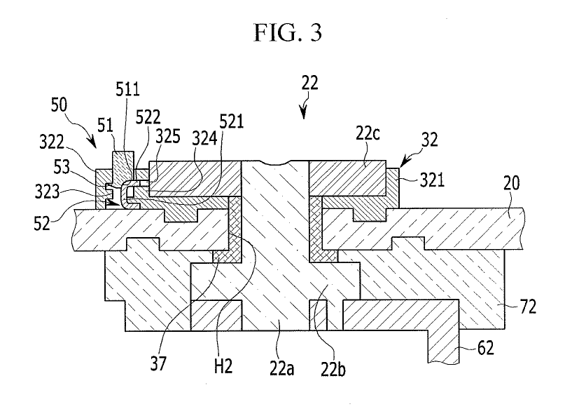

FIG. 3 illustrates a cross-sectional view before the electrification switch 50 provided to the positive terminal 22 of FIG. 2 is manipulated. Referring to FIG. 2 and FIG. 3, the positive terminal 22 and the electrification switch 50 will now be described.

The electrification switch 50 may be installed in the positive insulator 32 for insulating the positive terminal 22 and to electrically connect the positive terminal 22 (which is electrically insulated from the cap plate 20 by the positive insulator 32) with the cap plate 20 depending on the conditions.

For example, in the cell state of the rechargeable battery 100 according to the first exemplary embodiment, the cap plate 20 may maintain the neutral state in which the negative and positive terminals 21 and 22 are electrically insulated from the cap plate 20 by the negative and positive insulators 31 and 32, and, by manipulation of the electrification switch 50, the cap plate 20 may be in the module assembly state of the rechargeable battery 100, in which the cap plate 20 may be electrically connected to the positive terminal 22. As used herein, the term manipulation is not limited to manipulation by hand and includes manipulation by tools and machines.

Referring to FIG. 3, the positive insulator 32 may include a terminal receiver 321 for receiving the positive terminal 22 and supporting the same, and a switch receiver 322 formed on one side of the terminal receiver 321 and receiving the electrification switch 50.

The electrification switch 50 may include a button 51 inserted into the switch receiver 322, and an access member 52 having a first end connected to the cap plate 20 in the switch receiver 322 and having a second end electrically accessing (e.g., electrically contacting) the positive terminal 22 according to manipulation of the button 51.

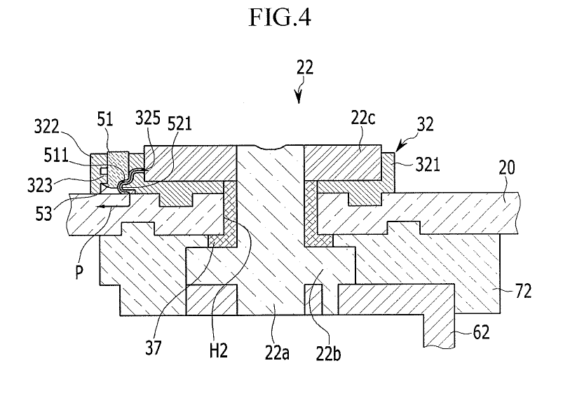

The button 51 may include a hook 53. The hook may maintain separation from a protrusion 323 protruding on an internal wall of the switch receiver 322 or may be hooked on the protrusion 323 in the positive insulator 32. The hook 53 may have a curved surface facing the cap plate 20 and a flat surface facing away from the cap plate 20. The flat surface of the hook 53 may extend horizontally from the button 51 and may engage respective first and second horizontal surfaces of the switch receiver 322 before and after manipulation of the button 51 (e.g., as illustrated in FIGS. 3 and 4).

The button 51 may be manipulated in an up-and-down direction (e.g., in a vertical direction perpendicular to the cap plate) in the switch receiver 322, and may push the access member 52 provided on one side in a lateral direction (refer to FIG. 3 and FIG. 4).

For example, the access member 52 may include a vertical unit 521 installed in a vertical direction in the switch receiver 322, and a horizontal unit 522 bent in a horizontal direction from the vertical unit 521. When the button 51 is manipulated to go down, tops of the vertical unit 521 and the horizontal unit 522 may be pushed in the horizontal direction and may access the positive terminal 22. In this instance, the horizontal unit 522 may access the plate terminal 22c.

The button 51 may include a groove 511 that is formed corresponding to the vertical unit 521 and the horizontal unit 522 and may fluently transmit manipulation force of the button 51 to the access member 52. For example the groove 511 may have a concave surface corresponding to a convex surface of the access member 52. The convex surface of the access member may be the bent portion of the access member 52.

The terminal receiver 321 may form a space for receiving the rivet terminal 22a and the plate terminal 22c of the positive terminal 22, and the terminal receiver 321 may be combined with an external side of the cap plate 20.

The switch receiver 322 may form a space for receiving the button 51 and the access member 52 of the electrification switch 50, and the switch receiver 322 may be integrally formed with the terminal receiver 321 on one side of the terminal receiver 321.

Before the button 51 is manipulated to go down, the button 51 may be supported on the horizontal unit 522 of the access member 52 and may protrude outside the switch receiver 322, and the button 51 may not go outside the switch receiver 322 because of the hook 53 that is hooked on the internal side of the switch receiver 322.

FIG. 4 illustrates a cross-sectional view when the electrification switch 50 is manipulated in FIG. 3. Referring to FIG. 4, the horizontal unit 522 of the access member 52 may access (i.e., may contact) the plate terminal 22c of the positive terminal 22 by manipulating the button 51 of the electrification switch 50 to go down. Thus, a current path (P) may be formed with the access member 52, and the cap plate 20 may be electrically connected to the positive terminal 22. That is, the cap plate 20 and the case 15 may be electrified with the positive polarity.

The positive insulator 32 may partition the terminal receiver 321 and the switch receiver 322 with a cell barrier 324. The cell barrier 324 may enable receiving of the button 51 and the access member 52, may lead a lifting operation of the button 51, and may include a through hole 325. The through hole 325 may lead the horizontal unit 522 of the access member 52 to the plate terminal 22c of the positive terminal 22 when the button 51 is manipulated to go down.

The cap plate 20 and the case 15 may be formed of, e.g., stainless steel having electrical resistance that is greater than that of aluminum. In this case, when a conductor (for example, a nail) penetrates the electrode assembly 10 through the case 15, the rechargeable battery 100 may reduce the amount of current that comes out of the positive terminal 22 and reaches the conductor through the case 15, thereby improving a characteristic of the rechargeable battery 100 in the event of penetration by the conductor.

A second exemplary embodiment will now be described, and aspects that are the same as discussed above will not be repeated.

The rechargeable battery 100 according to the first exemplary embodiment includes an external short-circuit unit 40 in the negative terminal 21 and includes an electrification switch 50 in the positive terminal 22.

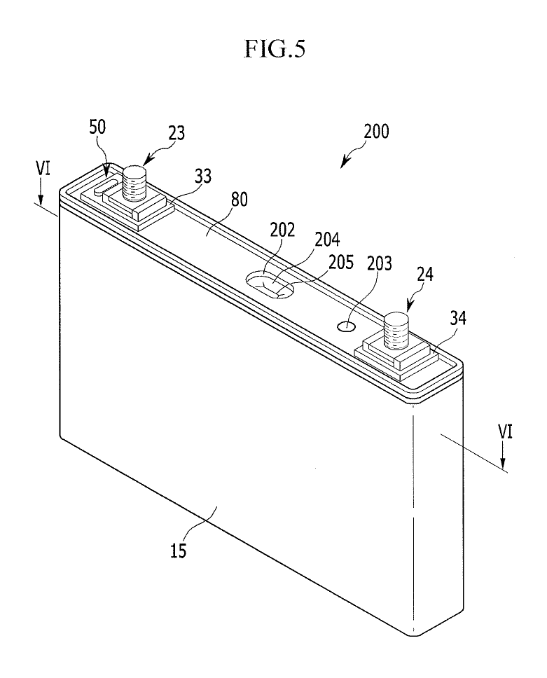

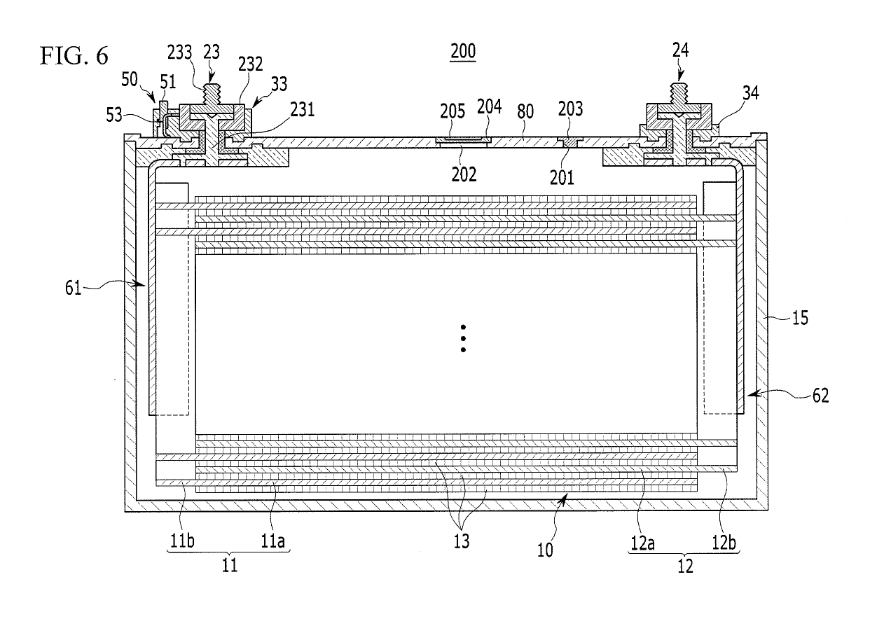

FIG. 5 illustrates a perspective view of a rechargeable battery 200 according to a second exemplary embodiment, and FIG. 6 illustrates a cross-sectional view with respect to a line VI-VI of FIG. 5. Referring to FIG. 5 and FIG. 6, the rechargeable battery 200 may include an electrification switch 50 in a negative terminal 23. The electrification switch may be provided to the positive terminal (not shown).

The negative and positive terminals 21 and 22 according to the first exemplary embodiment (not shown) may be applied to the rechargeable battery according to the second exemplary embodiment, or as illustrated in FIGS. 5-7, negative and positive terminals 23 and 24 applied to the rechargeable battery 200 according to the second exemplary embodiment may have different configurations from the negative and positive terminals according to the first exemplary embodiment.

The negative and positive terminals 23 and 24 are formed with the same configuration, so the negative terminal 23 will be described and a description of the positive terminal 24 will not be repeated. An internal configuration of a cap plate 80 and the negative and positive terminals 23 and 24 in the second exemplary embodiment corresponds to the internal configuration of the cap plate 80 and the negative and positive terminals 21 and 22 according to the first exemplary embodiment. Therefore, the internal configuration of the cap plate 80 and the negative and positive terminals 23 and 24 will not be repeated, and an external configuration of the cap plate 80 and the negative terminal 23 will now be described.

The negative terminal 23 may be installed by providing a negative insulator 33 in a terminal hole H1 formed in the cap plate 80, and the negative terminal 23 may form an electrical insulation configuration with the cap plate 80.

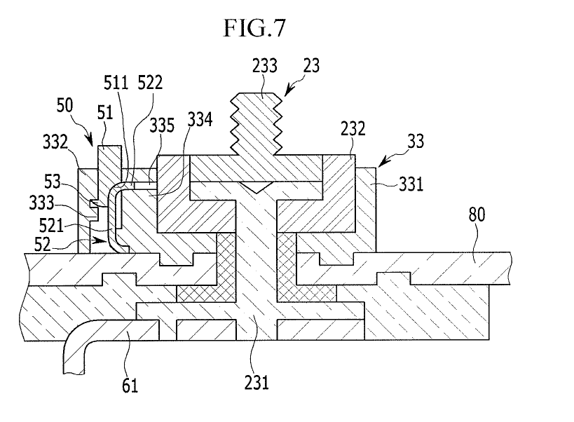

FIG. 7 illustrates a cross-sectional view before the electrification switch 50 provided to the negative terminal 23 of FIG. 6 is manipulated. Referring to FIG. 6 and FIG. 7, the negative terminal 23 may include a plate terminal 232 connected to a rivet terminal 231 that is drawn out from inside (e.g., passes through) the cap plate 80, and a screw 233 connected to the plate terminal 232.

The electrification switch 50 may be provided to the negative insulator 33 and may electrically connect the negative terminal 23 (which is electrically insulated from the cap plate 80 by the negative insulator 33) with the cap plate 80, according to manipulation of the electrification switch 50.

For example, in the cell state of the rechargeable battery 200 according to the second exemplary embodiment, the cap plate 80 may maintain the electrically insulated neutral state with the negative and positive terminals 23 and 24 by the negative and positive insulators 33 and 34, and, by manipulation of the electrification switch 50, the cap plate 80 may be in the module assembly state of the rechargeable battery 200, in which the cap plate 80 may be electrically connected to the negative terminal 23.

The negative insulator 33 may include a terminal receiver 331 for receiving the negative terminal 23 and supporting the same, and a switch receiver 332 formed on one side of the terminal receiver 331 and receiving the electrification switch 50.

The electrification switch 50 may include a button 51 inserted into the switch receiver 332, and an access member 52 having a first end connected to the cap plate 80 in the switch receiver 332 and having a second end electrically accessing (e.g., electrically contacting) the positive terminal 23 according to a manipulation of the button 51.

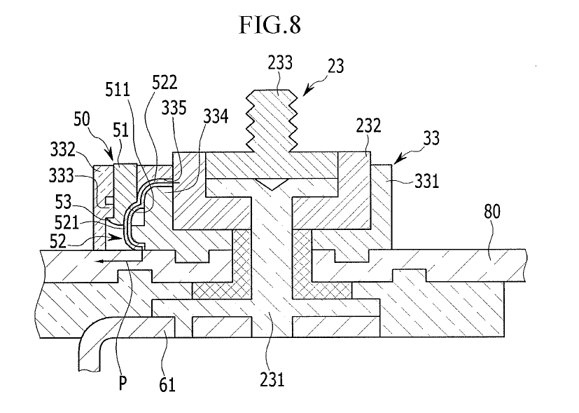

The button 51 may include a hook 53. The hook may maintain separation from a protrusion 333 protruding on an internal wall of the switch receiver 332 or may be hooked on the protrusion 333 in the negative insulator 33. The hook 53 may have a curved surface facing the cap plate 80 and a flat surface facing away from the cap plate 80. The flat surface of the hook 53 may extend horizontally from the button 51 and may engage respective first and second horizontal surfaces of the switch receiver 332 before and after manipulation of the button 51 (e.g., as illustrated in FIGS. 7 and 8).

The button 51 may be manipulated in an up-and-down direction (e.g., in a vertical direction perpendicular to the cap plate) in the switch receiver 332, and may push the access member 52 provided on one side in a lateral direction (refer to FIG. 7 and FIG. 8).

For example, the access member 52 may include a vertical unit 521 installed in a vertical direction in the switch receiver 332, and a horizontal unit 522 bent in a horizontal direction from the vertical unit 521. When the button 51 is manipulated to go down, tops of the vertical unit 521 and the horizontal unit 522 may be pushed in the horizontal direction and access the negative terminal 23. In this instance, the horizontal unit 522 may access the plate terminal 232.

The button 51 may include a groove 511 for partially receiving the access member 52 and for fluently transmitting the manipulation force to the access member 52. The groove 511 may be formed corresponding to the vertical unit 521 and the horizontal unit 522. For example the groove 511 may have a concave surface corresponding to a convex surface of the access member 52. The convex surface of the access member may be the bent portion of the access member 52.

A terminal receiver 331 may form a space for receiving the rivet terminal 231 and the plate terminal 232 of the negative terminal 23, and the terminal receiver 331 may be combined with the external side of the cap plate 80.

The switch receiver 332 may form a space for receiving the button 51 and the access member 52 of the electrification switch 50, and the switch receiver 332 may be integrally formed with the terminal receiver 331 at one side of the terminal receiver 331.

Before the button 51 is manipulated to go down, the button 51 may be supported on the horizontal unit 522 of the access member 52 and may protrude outside the switch receiver 332, and the button 51 may not go outside the switch receiver 332 because of the hook 53 that is hooked on the internal side of the switch receiver 332.

FIG. 8 illustrates a cross-sectional view when an electrification switch 50 of FIG. 7 is manipulated. Referring to FIG. 8, the horizontal unit 522 of the access member 52 may access (i.e., may contact) the plate terminal 232 of the negative terminal 23 by manipulating the button 51 of the electrification switch 50 to go down. Therefore, a current path (P) may be formed with the access member 52, and the cap plate 80 may be electrically connected to the negative terminal 23. That is, the cap plate 80 and the case 15 may be electrified with the negative polarity.

The negative insulator 33 may partition the terminal receiver 331 and the switch receiver 332 with a cell barrier 334. The cell barrier 334 may form a through hole 335 for progressing the horizontal unit 522 of the access member 52 to the plate terminal 232 of the negative terminal 23 when the button 51 is manipulated to go down.

In the second exemplary embodiment, the cap plate 80 and the case 15 may be formed of, e.g., aluminum. In this case, the cap plate 80 and the case 15 may be electrified with the negative polarity upon manipulation of the button 51, so the rechargeable battery 200 according to the second exemplary embodiment may reduce an electrification area of the positive electrode for generating electrons in a corrosion mode, thereby improving corrosion resistance.

By way of summary and review, a rechargeable battery may include an electrode assembly having a positive electrode and a negative electrode provided on either side of a separator, a case accommodating the electrode assembly, a cap plate sealing an opening of the case, and an electrode terminal penetrating the cap plate and electrically connected to the electrode assembly. For example, the rechargeable battery may charge an outer side (e.g., the cap plate and the case) with a positive polarity or a negative polarity, or it can maintain a neutral state. When the outer side is charged with the positive polarity, the rechargeable battery may be dangerous when it is handled. Also, when the outer side is charged with the negative polarity, the rechargeable battery may internally short-circuit and explode when a conductor passes through an electrode assembly. That is, a penetration characteristic of the conductor may cause a problem.

The above circumstances may be addressed in a rechargeable battery according to the embodiments. The rechargeable battery according to the embodiments may have a varying electrification polarity of a cap plate and a case. The rechargeable battery according to the embodiments may allow for improved characteristics in the event of penetration by a conductor, e.g., by reducing the amount of current that reaches the conductor. Also, the rechargeable battery according to the embodiments may allow for improved corrosion resistance, e.g., by reducing an electrification area generating electrons.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
a case that receives an electrode assembly;
a cap plate that closes and seals an opening of the case;
an electrode terminal that passes through the cap plate and is electrically connected to the electrode assembly;
an insulator between the electrode terminal and the cap plate, the insulator electrically insulating the electrode terminal and the cap plate; and
an electrification switch in the insulator, the electrification switch electrically connecting the electrode terminal to the cap plate according to manipulation of the electrification switch.

2. The rechargeable battery as claimed in claim 1, wherein:
the electrode terminal includes:
a negative terminal connected to a negative electrode of the electrode assembly, and
a positive terminal connected to a positive electrode of the electrode assembly,
the insulator includes a positive insulator that insulates the positive terminal, and
the electrification switch is in the positive insulator.

3. The rechargeable battery as claimed in claim 2, wherein the positive insulator includes:
a terminal receiver that receives and supports the positive terminal, and
a switch receiver that is on one side of the terminal receiver and receives the electrification switch.

4. The rechargeable battery as claimed in claim 3, wherein the electrification switch includes:
a button in the switch receiver, and
an access member having:
a first end connected to a portion of the cap plate in the switch receiver, and
a second end that electrically accesses the positive terminal according to manipulation of the button.

5. The rechargeable battery as claimed in claim 4, wherein:
the button has a first manipulation state and a second manipulation state,
when the button is in the first manipulation state, a top surface of the button is a first distance from the cap plate and the second end of the access member is spaced from the positive terminal,
when the button is in the second manipulation state, the top surface of the button is a second distance from the cap plate, and the second end of the access member contacts the positive terminal, and
the first distance is greater than the second distance.

6. The rechargeable battery as claimed in claim 4, wherein the button includes a hook that hooks onto a protrusion protruding from an internal wall of the switch receiver according to manipulation of the button.

7. The rechargeable battery as claimed in claim 6, wherein:
the access member includes:
a vertical unit that extends in a vertical direction in the switch receiver, and
a horizontal unit bent in a horizontal direction from the vertical unit, and
the horizontal unit is pushed in the horizontal direction and accesses the positive terminal by pushing the button down.

8. The rechargeable battery as claimed in claim 7, wherein the button includes a groove that corresponds to the vertical unit and the horizontal unit.

9. The rechargeable battery as claimed in claim 8, wherein:
the positive insulator includes a cell barrier that partitions the terminal receiver and the switch receiver,
the cell barrier defines a through hole for the horizontal unit to progress to the positive terminal.

10. The rechargeable battery as claimed in claim 2, further comprising:
an external short-circuit unit between the negative terminal and the cap plate, the short-circuit unit short-circuiting the negative terminal to the cap plate when an internal pressure is increased.

11. The rechargeable battery as claimed in claim 2, wherein the case and the cap plate are made of aluminum.

12. The rechargeable battery as claimed in claim 1, wherein:
the electrode terminal includes:
a negative terminal connected to a negative electrode of the electrode assembly, and
a positive terminal connected to a positive electrode of the electrode assembly,
the insulator includes a negative insulator that insulates the negative terminal, and
the electrification switch is in the negative insulator.

13. The rechargeable battery as claimed in claim 12, wherein the negative insulator includes:
a terminal receiver that receives and supports the negative terminal, and
a switch receiver that is on one side of the terminal receiver and receives the electrification switch.

14. The rechargeable battery as claimed in claim 13, wherein the electrification switch includes:
a button in the switch receiver, and
an access member having:
a first end connected to a portion of the cap plate in the switch receiver, and
a second end that electrically accesses the negative terminal according to manipulation of the button.

15. The rechargeable battery as claimed in claim 14, wherein:
the button has a first manipulation state and a second manipulation state,
when the button is in the first manipulation state, a top surface of the button is a first distance from the cap plate and the second end of the access member is spaced from the negative terminal,
when the button is in the second manipulation state, the top surface of the button is a second distance from the cap plate, and the second end of the access member contacts the negative terminal, and
the first distance is greater than the second distance.

16. The rechargeable battery as claimed in claim 14, wherein the button includes a hook that hooks onto a protrusion protruding from an internal wall of the switch receiver according to manipulation of the button.

17. The rechargeable battery as claimed in claim 14, wherein:
the access member includes:
a vertical unit that extends in a vertical direction in the switch receiver, and
a horizontal unit bent in a horizontal direction from the vertical unit, and
the horizontal unit is pushed in the horizontal direction and accesses the negative terminal by pushing the button down.

18. The rechargeable battery as claimed in claim 17, wherein the button includes a groove that corresponds to the vertical unit and the horizontal unit.

19. The rechargeable battery as claimed in claim 18, wherein:
the negative insulator includes a cell barrier that partitions the terminal receiver and the switch receiver,
the cell barrier defines a through hole for the horizontal unit to progress to the negative terminal.

20. The rechargeable battery as claimed in claim 12, wherein the case and the cap plate are made of stainless steel.
